(19) United States
(12) Patent Application Publication
(10) Pub. No.: US 2014/0141370 A1
(43) Pub. Date: May 22, 2014

(54) FINE SPHERICAL SILICA POWDER AND ELECTROSTATIC CHARGE IMAGE DEVELOPING TONER EXTERNAL ADDITIVE USING THE FINE SPHERICAL SILICA POWDER

(71) Applicant: DENKI KAGAKU KOGYO KABUSHIKI KAISHA, TOKYO (JP)

(72) Inventors: Shuji SASAKI, Omuta-shi (JP); Masaaki HIDESHIMA, Omuta-shi (JP); Hideaki SONODA, Omuta-shi (JP); Takahisa MIZUMOTO, Omuta-shi (JP)

(73) Assignee: DENKI KAGAKU KOGYO KABUSHIKI KAISHA, TOKYO (JP)

(21) Appl. No.: 14/165,664

(22) Filed: Jan. 28, 2014

Related U.S. Application Data
(63) Continuation-in-part of application No. PCT/JP2012/069160, filed on Jul. 27, 2012.

(30) Foreign Application Priority Data
Jul. 29, 2011 (JP) 2011-166623

(51) Int. Cl. G03G 9/08

(52) U.S. Cl. CPC G03G 9/0819
USPC 430/111.4; 428/402

(57) ABSTRACT

Provided is a suitable toner external additive which has an excellent spacer effect, without causing image defects in repeated image formation and which is suitable in preparing a toner with stable printing properties and to provide a fine spherical silica powder suitable for adding to the toner additive. A fine spherical silica power having an average particle size measured by a laser diffraction/scattering distribution measuring apparatus of 0.090 μm or more and 0.140 μm or less, a particle content ratio of 5.0% by mass or more and 25.0% by mass or less when the particle diameter is 0.150 μm or more, and a particle content ratio of 1.0% by mass or less when the particle diameter is 0.300 μm or more.

### CROSS REFERENCE TO RELATED APPLICATIONS

This application is based upon and claims the benefit of priority from the prior Japanese Patent Application No. 2011-166623, filed on Jul. 29, 2011 and PCT International Application PCT/JP2012/069160, filed on Jul. 27, 2012, the entire contents of which are incorporated herein by reference.

### FIELD

The present invention relates to a fine spherical silica powder and an electrostatic charge image developing toner external additive using the fine spherical silica powder.

### BACKGROUND

Conventionally, in an electrostatic charge image developing toner used in digital copiers or laser printers, in order to improve fluidity and stabilize charging characteristics, surface treated fine silica powder is used as a toner external additive. The characteristics required in the fine silica powder are high hydrophobicity in order to reduce changes in the amount of charge caused by humidity, and moreover dispersion with a small amount of aggregation so that the toner surface can be uniformly coated. Although an ultrafine powder having specific surface area of the fine silica powder of about 200 to 500 m²/g is used, it has been confirmed that the ultrafine silica powder becomes buried in the toner particle surface during repeated formation of images which causes a drop in toner fluidity, frictional electrification amount and transfer performance and the like which leads to image defects.

A method of combining a fine inorganic powder with a comparatively large particle diameter with a specific surface area of less than 80 m²/g is proposed in order to reduce the burial of the ultrafine silica powder (Japanese Laid Open Patent Publication No. 1-15-346682 and Japanese Laid Open Patent Publication No. 2000-81723). The fine inorganic powder with a comparatively large particle size shows a spacer effect of reducing the stress produced when toner pairs are in direct contact. In this way, methods to suppress the burial of ultrafine silica fine powder and extend the life of a toner have been taken.

However, in recent years there is a tendency to decrease the amount of heat applied when fixing the toner from the viewpoint of reducing the power consumption of digital copiers or laser printers and consequently there is a rapid progress in the reduction of the toner resin diameter and low melting point. Together with this, further improvements are required even on the spacer effects of fine silica powder used in a toner external additive.

### SUMMARY

An aim of the present invention is to provide a suitable toner external additive which has an excellent spacer effect, without causing image defects in repeated image formation and which is suitable in preparing a toner with stable printing properties and to provide a fine spherical silica powder suitable for adding to the toner additive.

As a result of keen research in order to achieve the aim described above, the present inventors have found a fine spherical silica powder which achieves this aim. The present invention is based on such findings which are summarized as follows.

(1) A fine spherical silica power having an average particle size measured by a laser diffraction/scattering distribution measuring apparatus of 0.090 μm or more and 0.140 μm or less, a particle content ratio of 5.0% by mass or more and 25.0% by mass or less when the particle diameter is 0.150 μm or more, and a particle content ratio of 1.0% by mass or less when the particle diameter is 0.300 μm or more.
(2) The fine spherical silica power in (1) having a particle content ratio of 0.5% by mass or less when the particle diameter is 0.050 μm or less measured by a laser diffraction/scattering distribution measuring apparatus, and a particle content ratio of 1.0% by mass or more and 15.0% by mass or less when the particle diameter exceeds 0.050 μm and 0.80 μm or less
(3) The fine spherical silica power in (1) or (2) having an average sphericity of 0.88 or more, wherein the ratio of the number of particles is 15% or less when sphericity is 0.85 or less and 8% or less when sphericity is 0.8 or less in particles with a projected area equivalent circle diameter measured by microscopy is 0.100 μm or more
(4) The fine spherical silica powder in any one of (1) to (3), wherein a Na⁺ concentration is 10 ppm or less and a Cl⁻ concentration is 5 ppm or less.
(5) The fine spherical silica powder obtained by a surface treatment to the fine spherical silica powder in any one of (1) to (4).
(6) The fine spherical silica powder in (5) wherein hexamethyldisilazane is used as a surface treatment agent.
(7) An electrostatic charge image developing toner external additive contains the fine spherical silica powder in (5) or (6).

### DESCRIPTION OF EMBODIMENTS

The present invention will be described in detail below. It is necessary that the fine spherical silica powder of the present invention has an average particle diameter measured by a laser diffraction/scattering distribution measuring apparatus of 0.090 μm or more and 0.140 μm or less. Particles having a particle diameter of 0.090 μm or more and 0.140 μm or less form an area which becomes the main constituent particle group of the fine spherical silica powder. When the average particle size is less than 0.090 μm, fine spherical silica powder buried in a toner resin increases when used as a toner external additive and a spacer effect is insufficient. On the other hand, when the average particle diameter exceeds 0.140 μm, fine spherical silica powder within a toner resin surface decreases and a spacer effect is still insufficient. A preferred average particle diameter is 0.095 μm or more and 0.135 μm or less, more preferably 0.100 μm or more and 0.130 μm or less.

It is necessary that the fine spherical silica powder of the present invention has a particle content ratio of 5.0% by mass or more and 25.0% by mass or less when the particle diameter measured by the laser diffraction/scattering distribution measuring apparatus is 0.150 μm or more and a particle content ratio of 1.0% by mass or less when the particle diameter is 0.300 μm or more. Particles with a particle diameter of 0.090 μm or more and 0.140 μm or less work to prevent burial of ultrafine silica powder of 200 to 500 m²/g which is added to the toner surface in order to provide fluidity, while particles with a particle diameter of 0.150 μm or more work to prevent burial of particles with a particle diameter of 0.090 μm or more and 0.140 μm or less which become the main constituent particle group of the fine spherical silica powder of the present invention. In this way, a spacer effect is improved significantly when used in a toner external additive and it is possible to improve temporal stability. When the particle content ratio of particles having a particle diameter of 0.150 μm or more is less than 5.0% by mass, the burial of particles with a particle diameter of 0.090 μm or more and 0.140 μm or less cannot be sufficiently prevented, and improving the temporal stability may be insufficient. On the other hand, when the particle content ratio of particles having a particle diameter of 0.150 μm or more exceeds 25.0% by mass, and/or the particle content ratio of particles having a particle diameter of 0.300 μm or more exceeds 1.0% by mass, a fine spherical silica powder coating rate of a surface of the toner resin drops which may adversely affect the charging characteristics of the toner as a result. A preferred particle content ratio of fine spherical silica powder having a particle diameter of 0.150 μm or more is 6.5% by mass or more and 20.0% by mass or less and more preferably 8% by mass or more and 15.0% by mass or less. In addition, a preferred particle content ratio of fine spherical silica powder having a particle diameter of 0.300 μm or more is 0.8% by mass or less and more preferably 0.5% by mass or less.

The fine spherical silica powder of the present invention is preferred to have a particle content ratio of 0.5% by mass or less when the particle diameter is 0.050 μm or less measured by a laser diffraction/scattering distribution measuring apparatus, and a particle content ratio of 1.0% by mass or more and 15.0% by mass or less when the particle diameter exceeds 0.050 μm and 0.080 μm or less. Particles having a particle diameter exceeding 0.050 μm and 0.080 μm or less form an intermediate particle diameter between particles having a particle diameter of 0.090 μm or more and 0.140 μm or less which become a main constituent particle group of the present invention, and 200 to 500 m²/g of ultrafine silica powder which is added to the toner surface for providing fluidity. As a result, gaps between each particle can be easily entered and temporal stability is improved. These effects are excellent when the particle content ratio is 0.5% by mass or less when the particle diameter is 0.050 μm or less, and the particle content ratio is 1.0% by mass or more and 15.0% by mass or less when the particle diameter exceeds 0.050 μm and 0.080 μm or less. A preferred particle content ratio of the fine spherical silica powder with a particle diameter exceeding 0.050 μm and 0.080 μm or less is 1.5% by mass or more and 12.5% by mass or less, and more preferably 2.0% by mass or more and 10.0% by mass or less. In order to obtain a good balance of each of the desired powder properties such as fluidity providing function or spacer function when the fine spherical silica powder of the present invention is combined with 200 to 500 m²/g of ultrafine silica powder, it is preferred that the particle content ratio is 0.5% by mass or less when the particle diameter is 0.050 μm or less.

Laser diffraction/scattering particle size distribution of the fine spherical silica powder of the present invention can be measured using a “LS-230” manufactured by Beckman Coulter. When performing the measurement, a pre-treatment using water as the solvent is performed for 2 minutes and distributed over an output of 200 W using an “ultrasonic generator UD-200 (ultra micro-chip TP-040 is loaded) manufactured by TOMY SEIKO Co., Ltd. In addition, a PIDS (Polarization Intensity Differential Scattering) concentration is adjusted to 45 to 55% by mass. Analysis of the particle size distribution was performed by dividing the range of 0.04 to 2000 μm to 116 by the width of the particle diameter channel log (μm)=0.04. 1.33 was used in the refractive index of water and 1.50 was used in the refractive index of the fine spherical silica powder. Furthermore, in the particle size distribution which was measured, particles where the accumulated weight becomes 50% have an average particle diameter.

It is preferred that the fine spherical silica powder of the present invention has particles with a projected area equivalent circle diameter of 0.100 μm measured by microscopy wherein an average sphericity is 0.88 or more, and the particle number ratio is 15% or less when sphericity is 0.85 or less, and the particle number ratio is 8% or less when sphericity is 0.80 or less. Particles with a low sphericity often have a structure or form aggregates and this tendency becomes significant the lower sphericity is. In particles with a projected area equivalent circle diameter of 0.100 μm measured by microscopy, the average sphericity is 0.88 or more and if the particle number ratio is 15% or less when sphericity is of 0.85 or less and the particle number ratio is 8% or less when sphericity is 0.80 or less, coating of an external additive to the toner surface and the spacer effect is excellent. Average sphericity of particles with a projected area circle equivalent diameter measured by microscopy of 0.100 μm or more is preferably 0.90 or more, and more preferably 0.92 or more. In addition, the particle number ratio when sphericity is 0.80 or less is preferably 13% or less and the particle number ratio when sphericity is 0.85 or less is preferably 6.5% or less, and the particle number ratio when sphericity is 0.85 or less is more preferably 10% or less and the particle number ratio when sphericity is 0.80 or less is more preferably 5% or less.

The sphericity of the fine spherical silica powder of the present invention can be measured by the following method. An particle image taken using a scanning electron microscope (for example, “JSM-6301 F” model manufactured by Nippon Electronics Co., Ltd), a transmission electron microscope (for example, “JEM-2000FX” model manufactured by Nippon Electronics Co., Ltd) is read into an image analysis device (for example, “MacView” manufactured by MOUNTECH) and a measurement is taken from the projected area (A) and perimeter length (PM) of the particle from the pictures. When an area of a true circle corresponding to the perimeter length (PM) is given as (B), because sphericity of that particle becomes NB, assuming a true circle having a perimeter length the same as the perimeter length (PM) of the sample, then B=π×(PM/2π)² since PM=2πr, B=πr², the sphericity of each particle becomes sphericity ═NB=A×4π/(PM)². The sphericity of 200 arbitrary particles with a projected area equivalent circle diameter of 0.100 μm obtained in this way was measured and the average value was used as the average sphericity. In addition, each particle number ratio was calculated from the number of particles with a sphericity of 0.85 or less or 0.80 or less from among these 200 particles.

The fine spherical silica powder of the present invention is preferred to have a Na⁺ concentration of 10 ppm or less and a Cl⁻ concentration of 5 ppm or less. When the Na⁺ concentration exceeds 10 ppm and/or the Cl⁻ concentration exceeds 5 ppm, the charge properties of a toner or the toner external additive deteriorate or it becomes difficult to control the amount of charge and developability and transfer performance may worsen. A Na⁺ concentration of 8 ppm or less and a Cl⁻ concentration of 4 ppm or less is preferred, more preferably a Na⁺ concentration of 5 ppm or less and a Cl⁻ concentration of 3 ppm or less.

The Na⁺ concentration of the fine spherical silica powder of the present invention can be measured using atomic absorption spectrometry and the Cl⁻ concentration can be measured using ion chromatography using the following procedure.

(1) Measurement of Na⁺ concentration: After placing a 10 g of sample and 70 ml of ion-exchanged water into a polyethylene container and shaking for 1 minute, the sample is placed into a dryer and left the sample at 95° C. for 20 hours and cool the sample. The water component which evaporates is added and quantified. Following this, centrifugation is performed and a supernatant is taken in a beaker and a test solution is obtained. Aside from this, a blank test solution is obtained by performing all the operations except the sample weights in the previous operation. The absorbance of a part of the test solution is measured using an atomic absorption photometer. The Na⁺ concentration is calculated from a calibration curve prepared in advance and the rate of content is calculated. A similar measurement for the blank test solution is performed and the results are corrected. “AA-6800” manufactured by Shimadzu Corporation can be exemplified as the atomic absorption photometer. An atomic absorption Na standard solution (concentration 1000 ppm) manufactured by Kanto Chemical Co., Inc. can be exemplified as a standard solution used to prepare a calibration curve. Furthermore, a frame when measuring was quantified by measuring absorbance at a wavelength of 589.0 nm using an air-acetylene flame.
(2) Measurement of Cl⁻ concentration: After placing a 10 g of sample and 70 ml of ion-exchanged water into a polyethylene container and shaking for 1 minute, the sample is placed into a dryer and left the sample at 95° C. for 20 hours to and cool the sample. The water component which evaporates is added and quantified. Following this, centrifugation is performed and a supernatant is taken in a beaker and a test solution is obtained. Aside from this, a blank test solution is obtained by performing all the operations except the sample weights in the previous operation. A part of the test solution is measured by ion chromatography. The Cl⁻ concentration is calculated from a calibration curve prepared in advance and the rate of content is calculated. A similar measurement for the blank test solution is performed and the results are corrected. “ICS-1500” manufactured by DIONEX Inc can be exemplified as the ion chromatograph. An ion chromatograph Cl⁻ standard solution (concentration 1000 ppm) manufactured by Kanto Chemical Co., Inc. can be exemplified as a standard solution used to prepare a calibration curve.

The manufacturing method of the fine spherical silica powder is preferred to be an oxidation reaction method of metal silicon in order to realize sphericity of the silica fine powder of the present invention and Na⁺ and Cl⁻ concentrations. For example, the fine spherical silica powder can be manufactured using a method of casting metal silicon into a high temperature field formed in a chemical flame or electric furnace and forming a spherical shape while causing an oxidation reaction (for example, Japanese Patent No. 1568168), or a method which sprays a metal silicon particle slurry into a flame and forms a spherical shape while causing an oxidation reaction (for example, Japanese Patent No. 2000-247626). The Na⁺ concentration of the metal silicon used is preferred to be 10 ppm or less and the Cl⁻ concentration is preferred to be 5 ppm or less.

In order to obtain the particle size of the fine spherical silica powder of the present invention, the fine spherical silica powder manufactured using the methods described above may also be classified. The classification method can be performed using a dry classification such as gravity classification or inertial classification, a wet classification such as sedimentation classification and water classification or a known method such as sieve classification using a sieve.

A surface treatment is preferably performed in the case where the fine spherical silica powder of the present invention is contained in a toner external additive. A silylating agent such as alkylchlorosilane, alkylalkoxysilane, hexamethyldisilazane, a titanate coupling agent, a fluorine-based silane coupling agent, silicone oil, silicone varnish, a coupling agent having an amino group or quaternary ammonium salt and a modified silicone oil can be used as the surface treatment agent used in the present invention. Among these, hexamethyldisilazane is preferred due to the height of hydrophobicity after a surface treatment. In addition, it is possible to achieve the surface treatment characteristics required according to purpose by using one type of these surface treatment agents alone, or by mixing or performing a surface treatment sequentially and gradually in the case of two or more types.

A method of spraying a raw solution of a surface treatment agent in a state where the spherical silica powder raw material is suspended or a method of gasifying a surface treatment agent and contacting to the fine spherical silica powder are examples of a surface treatment method of a spherical silica powder raw material. In addition, in the case where a hydrophobic surface treatment is performed with a silylating agent such as hexamethylsilazane, first water is sprayed and mixed and the hydrophobic surface treatment can be performed after activating a silanol group.

The fine spherical silica powder of the present invention is preferred to have a degree of hydrophobicity of 60% or more. When hydrophobicity is less than 60%, the charge amount of the toner in a high humidity environment changes and fluidity drops when toner particles aggregate. 65% or more is preferred and more preferably 70% or more. The degree of hydrophobicity can be measured by the following method. That is, 50 ml of ion-exchanged water and a 0.2 g sample are placed into a beaker and methanol is added dropwise from a burette while stirring with a magnetic stirrer. The powder continues to settle gradually as the methanol concentration in the beaker increases and the volume % of methanol in the mixed solution of methanol and the ion-exchanged water when the whole amount has sank is given as the degree of hydrophobicity (%).

The amount of surface treated fine spherical silica powder to the toner is usually preferably 0.1 to 10 parts by mass relative to 100 parts by mass of the toner and more preferably 0.5 to 5 parts by mass. If the blending amount is too small, the amount adhered to the toner is small and sufficient spacer effects cannot be obtained, and the charging properties of the toner may adversely affected when too large.

The silica powder of the toner external additive containing the fine spherical silica powder of the present invention is not limited to the fine spherical silica powder of the present invention which is used alone, for example, about 200 to 500 m^{2/}g of ultrafine powder silica with a high fluidizing effect can also be used in combination with.

It is possible to use a known toner composed mainly of a binder resin and colorant as an electrostatic charge image developing toner added with a toner external additive toner containing the fine spherical silica powder of the present invention. In addition, a charge control agent may also be added according to necessity.

The electrostatic charge image developing toner added with a toner external additive containing the fine spherical silica powder of the present invention can be used as a one component developer, or as a two-component developer by mixing with a carrier. In the case where it is used as a two-component developer, the toner external additive is not added to the toner particles in advance but may be added when mixing the toner and carrier and performing surface coating of the toner. Iron powder or known products resin-coated on the surface thereof are used as the carrier.

### EXAMPLES

The present invention is further explained in detail below using examples and comparative examples.

### Examples 1-13 and Comparative Examples 1-8

Fine spherical silica powder was produced by arranging an LPG-oxygen mixed burners with a double pipe structure capable of forming an inner flame and outer flame at the top of a combustion furnace, and using a device comprising directly connected capture lines at the bottom. Two fluid nozzles for spraying a slurry are further arranged at the center of the burner, and a slurry comprised from metal silicon powder (average particle diameter 9.8 μm, Na⁺ concentration: 0.2 ppm, Cl⁻ concentration: 0.4 ppm) and water was injected from the center at a feed rate of 20.0 kg/Hr. Oxygen was supplied from the periphery. Formation of the flame was performed by arranging a few tens of pores at the outlet of the double tube burner and from this injecting a mixed gas of LPG and oxygen. Fine spherical silica powder produced by injecting from the two fluid nozzles and passing through a flame is air transported through capture lines using a blower and captured in a bag filter. Furthermore, adjustment of the sphericity of the fine spherical silica powder was performed by adjusting the water slurry concentration of the metal silicon powder mixed with water and the metal silicon powder in the range of 30 to 70% by mass.

The captured fine spherical silica powder was subjected to elutriation using isopropyl alcohol. The fine spherical silica powder within the supernatant or fine spherical silica powder which has sunk was collected and dried at 120° C. for 12 hours. These were combined as appropriate and the desired fine spherical silica powder A to U was obtained. The average particle size measured by the laser diffraction/scattering particle size distribution measuring apparatus of the fine spherical silica powder A to U, particle content ratio when particle the diameter is 0.150 μm or more, particle content ratio when the particle diameter is 0.300 μm or more, particle content ratio when the particle diameter is 0.050 μm or less, particle content ratio when the particle diameter exceeds 0.050 μm and 0.080 μm or less, average sphericity of the particles when the projected area equivalent circle diameter is 0.100 μm or more by microscopy, particle number ratio when sphericity is 0.85 or less and particle number ratio when sphericity is 0.80 or less are shown in Table 1 and Table 2. Analysis of the projected area equivalent circle diameter of the particles and sphericity was performed by importing an image with a magnification of 10000 and a resolution of 2048×1536 taken using a scanning electron microscope JSM-6301F model manufactured by Nippon Electronics Co., Ltd into a computer and using a MacView Ver. 4 image analysis device manufactured by MOUNTECH. The analysis was performed using a simple import tool as a particle selection tool. Furthermore, Na⁺ concentrations of the fine spherical silica powder obtained were 5 ppm or less and Cl⁻ concentrations were 3 ppm or less.

100 g of each fine spherical silica powder A to U were put into a fluid layer (“vibration fluidized bed apparatus VUA-15” manufactured by Central Chemical Engineering Co., Ltd, after 2 g of water was sprayed on to fluidized N₂ gas and fluid mixed for 5 minutes, 4 g of hexamethyldisilazane (“HMDS-3” manufactured by Shin-Etsu Chemical Co., Ltd) was sprayed and fluid mixed for 30 minutes. After fluid mixing, the temperature was raised to 130° C. in order to remove ammonia generated while passing nitrogen gas and the hydrophobic spherical fine silica powder was obtained. The degree of hydrophobicity of the fine spherical silica powder which was obtained was 70% or more in either case.

In order to evaluate the properties of the fine spherical silica powder surface-treated with hexamethyldisilazane as a toner external additive, the degree of compression degree, the compression rate of change and external additive coating ratio were measured according to the following methods. The results of each are shown in Table 1 and Table.

### (1) Degree of Compression

5 g of a powder surface-treated fine spherical silica powder A to U, 500 g of a cross-linked acrylic resin powder having an average particle size of 5 μm (commercial name: “MX-500” manufactured by Soken Chemical & Engineering Co., Ltd.) and 5 g of commercially available fumed silica 200 m²/g for providing fluidity were put in a Henschel mixer (“FM-10B” manufactured by Mitsui Miike Machinery Co., Ltd) and a pseudo toner was produced by mixing for 3 minutes at 1000 rpm. The degree of compression of the pseudo toner was evaluated using a powder tester (“PT-E” manufactured by Hosokawa Micron). The degree of compression is calculated by the following formula.

Degree of compression=(hardening appearance ratio−loose appearance ratio)/hardening appearance ratio×100(%)

Furthermore, the loose appearance ratio is a ratio measured in the state where the pseudo toner is put into a 100 ml cup and no tapping is performed, and the hardening appearance ratio is an appearance ratio measured by placing the pseudo toner into a 100 ml cup and after tapping 180 times at a rate of once per second. Fluidity became better the smaller the value of the degree of compression.

### (2) Compression Rate of Change

The compression rate measurement was performed by changing the mixing time of the Henschel mixer from 3 minutes to 30 minutes and the compression rate of change was calculated from the following equation.

The compression rate of change=degree of compression when mixing time is 30 minutes/degree of compression when mixing time is 3 minutes

When the compression rate of change is close to 1, that is the smaller the change in the degree of compression, the better are the temporal stability properties. If stability over time is good, it is possible to prepare a toner with stable printing properties when it is used as an external additive.

### (3) External Additive Coating Ratio

15 g of a powder surface-treated fine spherical silica powder A to U, 500 g of a cross-linked acrylic resin powder having an average particle size of 5 μm (commercial name: “MX-500” manufactured by Soken Chemical & Engineering Co., Ltd.) were put in a Henschel mixer (“FM-10B” manufactured by Mitsui Miike Machinery Co., Ltd) and a pseudo toner was produced by mixing for 3 minutes at 1000 rpm. After fixing this mixed sample using carbon paste to the sample stage, osmium coating was performed and the sample was observed using an electron microscope (“JSM-6301F” manufactured by JEOL Ltd). An image with a magnification of 15000 and a resolution of 2048×1536 was imported into a computer and the projection area of cross-linked acrylic resin powder and projection area of the fine spherical silica powder were measured using an image analysis device (MacView Ver. 4 manufactured by MOUNTECH). In addition, analysis was performed using a simple tool as a particle selection tool the external additive coating ratio per pseudo toner was calculated from the following equation.

external additive coating ratio per pseudo toner=(total projection area of fine spherical silica powder adhered to one cross-linked acrylic resin powder surface/projection area of one cross-linked acrylic resin powder)×100(%)

The external additive coating ratio for 20 pseudo toners was calculated and the average value was used as the average external additive coating ratio.

TABLE 1

| | Examples | | | | | | | | | |
|---|---|---|---|---|---|---|---|---|---|---|
| Items | 1 | 2 | 3 | 4 | 5 | 6 | 7 | 8 | 9 | 10 |
| Symbol of the fine | A | B | C | D | E | F | G | H | I | J |
| spherical silica | | | | | | | | | | |
| fine power | | | | | | | | | | |
| Average particle | 0.120 | 0.115 | 0.098 | 0.110 | 0.104 | 0.128 | 0.130 | 0.091 | 0.094 | 0.134 |
| size (μm) | | | | | | | | | | |
| Particle content | 12.1 | 14.3 | 7.0 | 8.2 | 7.7 | 19.7 | 15.3 | 5.6 | 6.8 | 20.9 |
| ratio when the | | | | | | | | | | |
| particle diameter | | | | | | | | | | |
| is 0.150 μm or | | | | | | | | | | |
| more (% by mass) | | | | | | | | | | |
| Particle content | 0.1 | 0.1 | 0.2 | 0.1 | 0.1 | 0.6 | 0.4 | 0.0 | 0.1 | 0.8 |
| ratio when the | | | | | | | | | | |
| particle diameter | | | | | | | | | | |
| is 0.300 μm or | | | | | | | | | | |
| more (% by mass) | | | | | | | | | | |
| Particle content | 0.1 | 0.1 | 0.2 | 0.2 | 0.1 | 0.0 | 0.1 | 0.1 | 0.7 | 0.0 |
| ratio when the | | | | | | | | | | |
| particle diameter | | | | | | | | | | |
| is 0.050 μm or | | | | | | | | | | |
| less (% by mass) | | | | | | | | | | |
| Particle content | 5.6 | 2.3 | 11.7 | 10.2 | 12.2 | 9.7 | 1.8 | 13.9 | 15.6 | 1.8 |
| ratio when the | | | | | | | | | | |
| particle diameter | | | | | | | | | | |
| exceeds 0.050 μm | | | | | | | | | | |
| and 0.080 μm or | | | | | | | | | | |
| less (% by mass) | | | | | | | | | | |
| Average sphericity | 0.95 | 0.91 | 0.91 | 0.90 | 0.96 | 0.88 | 0.86 | 0.93 | 0.87 | 0.92 |
| of the particles of | | | | | | | | | | |
| 0.100 μm or more | | | | | | | | | | |
| Particle number | 7.5 | 12.5 | 6.5 | 9.0 | 4.5 | 13.5 | 13.5 | 8.0 | 15.5 | 7.0 |
| ratio when | | | | | | | | | | |
| sphericity is 0.85 | | | | | | | | | | |
| or less (%) | | | | | | | | | | |
| Particle number | 3.0 | 6.5 | 4.5 | 6.0 | 1.5 | 8.0 | 6.5 | 4.0 | 9.0 | 3.0 |
| ratio when | | | | | | | | | | |
| sphericity is 0.80 | | | | | | | | | | |
| or less (%) | | | | | | | | | | |
| Degree of | 20 | 22 | 25 | 22 | 24 | 24 | 26 | 27 | 29 | 24 |
| Compression (%) | | | | | | | | | | |
| Compression rate | 1.05 | 1.05 | 1.12 | 1.09 | 1.13 | 1.08 | 1.12 | 1.15 | 1.14 | 1.13 |
| of change (%) | | | | | | | | | | |
| Average external | 20 | 20 | 21 | 20 | 22 | 16 | 19 | 22 | 21 | 14 |
| additive coating | | | | | | | | | | |
| ratio (%) | | | | | | | | | | |

TABLE 2

| | Examples | | | Comparative Examples | | | | | | | |
|---|---|---|---|---|---|---|---|---|---|---|---|
| Items | 11 | 12 | 13 | 1 | 2 | 3 | 4 | 5 | 6 | 7 | 8 |
| Symbol of the fine | K | L | M | N | 0 | P | Q | R | S | T | U |
| spherical silica | | | | | | | | | | | |
| fine power | | | | | | | | | | | |
| Average particle | 0.136 | 0.092 | 0.137 | 0.087 | 0.144 | 0.093 | 0.138 | 0.136 | 0.086 | 0.116 | 0.142 |
| size (μm) | | | | | | | | | | | |
| Particle content | 22.5 | 5.3 | 24.2 | 4.2 | 27.1 | 4.6 | 24.6 | 26.3 | 6.9 | 25.2 | 21.3 |
| ratio when the | | | | | | | | | | | |
| particle diameter | | | | | | | | | | | |
| is 0.150 μm or | | | | | | | | | | | |
| more (% by mass) | | | | | | | | | | | |
| Particle content | 0.5 | 0.2 | 0.9 | 0.0 | 1.3 | 0.1 | 1.1 | 0.9 | 0.3 | 1.1 | 0.2 |
| ratio when the | | | | | | | | | | | |
| particle diameter | | | | | | | | | | | |
| is 0.300 μm or | | | | | | | | | | | |
| more (% by mass) | | | | | | | | | | | |
| Particle content | 0.0 | 0.6 | 0.0 | 0.6 | 0.0 | 0.4 | 0.1 | 0.0 | 0.4 | 0.8 | 0.1 |
| ratio when the | | | | | | | | | | | |
| particle diameter | | | | | | | | | | | |
| is 0.050 μm or | | | | | | | | | | | |
| less (% by mass) | | | | | | | | | | | |
| Particle content | 0.8 | 14.8 | 1.1 | 16.0 | 0.6 | 14.2 | 0.7 | 1.3 | 13.8 | 16.8 | 1.1 |
| ratio when the | | | | | | | | | | | |
| particle diameter | | | | | | | | | | | |
| exceeds 0.050 μm | | | | | | | | | | | |
| and 0.080 μm or | | | | | | | | | | | |
| less (% by mass) | | | | | | | | | | | |
| Average sphericity | 0.90 | 0.89 | 0.89 | 0.93 | 0.90 | 0.87 | 0.93 | 0.89 | 0.91 | 0.88 | 0.91 |
| of the particles of | | | | | | | | | | | |
| 0.100 μm or more | | | | | | | | | | | |
| Particle number | 11.0 | 14.0 | 12.5 | 5.5 | 11.0 | 16.0 | 6.5 | 13.5 | 11.5 | 16.5 | 12.0 |
| ratio when | | | | | | | | | | | |
| sphericity is 0.85 | | | | | | | | | | | |
| or less (%) | | | | | | | | | | | |
| Particle number | 4.5 | 7.5 | 5.5 | 2.5 | 4.5 | 8.5 | 4.0 | 6.5 | 6.0 | 9.0 | 6.5 |
| ratio when | | | | | | | | | | | |
| sphericity is 0.80 | | | | | | | | | | | |
| or less (%) | | | | | | | | | | | |
| Degree of | 29 | 29 | 28 | 37 | 35 | 35 | 30 | 31 | 35 | 37 | 31 |
| Compression (%) | | | | | | | | | | | |
| Compression rate | 1.17 | 1.17 | 1.14 | 1.22 | 1.23 | 1.23 | 1.30 | 1.23 | 1.14 | 1.11 | 1.19 |
| of change (%) | | | | | | | | | | | |
| Average external | 13 | 20 | 13 | 23 | 7 | 21 | 8 | 9 | 22 | 9 | 10 |
| additive coating | | | | | | | | | | | |
| ratio (%) | | | | | | | | | | | |

As is clear from the examples and the comparison examples, according to the present invention, a toner external additive is provided suitable for preparing a toner with stable print characteristics and has excellent spacer effects without causing defects even in repeated image formation. In addition, a fine spherical silica powder is provided suitable for adding to the toner external additive.

The fine spherical silica powder of the present invention is used as in a copier or laser printer or the like and is used as a toner external additive for electrophotographs.

According to the present invention, a toner external additive is provided suitable for preparing a toner with stable print characteristics and has excellent spacer effects without causing defects even in repeated image formation. In addition, a fine spherical silica powder is provided suitable for adding to the toner external additive.

1. A fine spherical silica power having an average particle size measured by a laser diffraction/scattering distribution measuring apparatus of 0.090 μm or more and 0.140 μm or less, a particle content ratio of 5.0% by mass or more and 25.0% by mass or less when the particle diameter is 0.150 μm or more, and a particle content ratio of 1.0% by mass or less when the particle diameter is 0.300 μm or more.

2. The fine spherical silica powder according to claim 1 having a particle content ratio of 0.5% by mass or less when the particle diameter is 0.050 μm or less measured by a laser diffraction/scattering distribution measuring apparatus, and a particle content ratio of 1.0% by mass or more and 15.0% by mass or less when the particle diameter exceeds 0.050 μm and 0.80 μm or less.

3. The fine spherical silica powder according to claim 1 having an average sphericity of 0.88 or more, wherein the ratio of the number of particles is 15% or less when sphericity is 0.85 or less and 8% or less when sphericity is 0.8 or less in particles with a projected area equivalent circle diameter measured by microscopy is 0.100 μm or more.

4. The fine spherical silica powder according to claim 1, wherein a Na⁺ concentration is 10 ppm or less and a Cl⁻ concentration is 5 ppm or less.

5. A fine spherical silica powder obtained by performing a surface treatment to the fine spherical silica powder according to claim 1.

6. The fine spherical silica powder according to claim 5, wherein hexamethyldisilazane is used as a surface treatment agent.

7. An electrostatic charge image developing toner external additive contains the fine spherical silica powder according to claim 5.

8. The fine spherical silica powder according to claim 2 having an average sphericity of 0.88 or more, wherein the ratio of the number of particles is 15% or less when sphericity is 0.85 or less and 8% or less when sphericity is 0.8 or less in particles with a projected area equivalent circle diameter measured by microscopy is 0.100 μm or more.

9. The fine spherical silica powder according to claim 2, wherein a Na⁺ concentration is 10 ppm or less and a Cl⁻ concentration is 5 ppm or less.

10. The fine spherical silica powder according to claim 3, wherein a Na⁺ concentration is 10 ppm or less and a Cl⁻ concentration is 5 ppm or less.

11. A fine spherical silica powder obtained by performing a surface treatment to the fine spherical silica powder according to claim 2.

12. A fine spherical silica powder obtained by performing a surface treatment to the fine spherical silica powder according to claim 3.

13. A fine spherical silica powder obtained by performing a surface treatment to the fine spherical silica powder according to claim 4.

14. The fine spherical silica powder according to claim 11, wherein hexamethyldisilazane is used as a surface treatment agent.

15. The fine spherical silica powder according to claim 12, wherein hexamethyldisilazane is used as a surface treatment agent.

16. The fine spherical silica powder according to claim 13, wherein hexamethyldisilazane is used as a surface treatment agent.

17. An electrostatic charge image developing toner external additive contains the fine spherical silica powder according to claim 14.

18. An electrostatic charge image developing toner external additive contains the fine spherical silica powder according to claim 15.

19. An electrostatic charge image developing toner external additive contains the fine spherical silica powder according to claim 16.
